(19) United States
(12) Patent Application Publication
(10) Pub. No.: US 2024/0391214 A1
(43) Pub. Date: Nov. 28, 2024

(54) FIRE-RESISTANT GLAZING

(71) Applicant: Pilkington Group Limited, Lathom (GB)

(72) Inventors: Lucas KRAMER, Gelsenkirchen (DE); Bianca KORTEWILLE, Gelsenkirchen (DE); Martin SCHADE, Gelsenkirchen (DE)

(21) Appl. No.: 18/686,520

(22) PCT Filed: Aug. 26, 2022
(86) PCT No.: PCT/GB2022/052201

§ 371 Date: Feb. 26, 2024

(30) Foreign Application Priority Data
Aug. 27, 2021 (GB) 2112325.2

(51) Int. Cl. B32B 17/06; B32B 17/10

(52) U.S. Cl. CPC B32B 17/069; B32B 17/10779; B32B 17/10908; B32B 2307/3065; B32B 2367/00

(57) ABSTRACT

A fire-resistant glazing is disclosed which comprises at least two transparent plies and at least one transparent fire-resistant layer wherein each fire-resistant layer is an interlayer for two plies and at least one fire-resistant interlayer comprises a hydrogel based on an aluminium 1,2,3-tricarboxy late, for example, aluminium citrate. A base solution and method for the production of the fire-resistant glazing is also disclosed.

The present invention is generally concerned with the use of a hydrogel based on an aluminium 1,2,3-tricarboxylate as a fire-resistant layer in a fire-resistant glazing.

The present invention provides a fire-resistant glazing having a fire-resistant layer comprising a hydrogel based on aluminium 1,2,3-tricarboxylate as well as a method for producing the fire-resistant glazing.

Fire-resistant glazings generally comprise a laminate structure of at least two transparent plies and at least one transparent fire-resistant layer disposed between the two plies.

Typically, the transparent plies are clear glass panes. The glass is normally a float glass. Less commonly, one or more of the transparent plies are clear panes of a polymer material such as a polycarbonate.

In many countries, building regulations require that a glazing provide a degree of fire-resistance depending (amongst other things) on the location of use of the glazing.

These regulations generally specify a minimum time during which the glazing must act as a barrier to the propagation of fire and/or smoke when the glazing is exposed to a fire.

One type of fire-resistant layer (often referred to as intumescent layer or interlayer) in use in fire-resistant glazings comprises an intumescent material.

The intumescent material swells or foams on heating to form a barrier on exposure of the fire-resistant glazing to fire which is resistant to fire propagation and highly insulating against smoke penetration.

The intumescence is often accompanied by a cooling effect and/or the release of water as water vapour from the intumescent material-both of which serve to reduce heat conduction through the glazing.

Another fire-resistant layer in use in fire-resistant glazings (often referred to as a “burn down” layer or interlayer) simply comprises a material which is resistant to fire propagation and to smoke penetration.

In general, however, fire-resistant layers comprise an inorganic or organic hydrogel of high (greater than 20%) water content which are obtained by curing a solution of inorganic or organic precursor(s) for the hydrogel in water.

One method for forming a fire-resistant glazing having such a fire-resistant layer is known as the “cast-in-place” (CIP) method.

In this method, an aqueous solution comprising a precursor or precursors for an inorganic or organic hydrogel is poured into a cavity formed by two opposing transparent plies and a seal provided between the transparent plies.

Thereafter, the cavity is sealed and the aqueous solution cured to form a layer of the inorganic or organic hydrogel between the transparent plies. The curing may be carried out by heating the aqueous solution to an appropriate temperature during an appropriate period in time.

In this method, the inorganic or organic hydrogel retains the water content of the aqueous solution which is poured into the cavity.

One commonly used aqueous solution for forming an intumescent hydrogel comprises one or more of an alkali metal silicate (and is known as water glass).

Another commonly used aqueous solution for forming an intumescent hydrogel comprises a silica sol or a mixture of one or more of an alkali metal silicate and a silica sol.

A commonly used aqueous solution for forming a (burn down) hydrogel comprises a dispersion of an acrylate monomer in water which monomer polymerises on curing to form a hydrogel.

These aqueous solutions normally also comprise a small amount of a curing agent or initiator, which may be an organic or inorganic compound, for initiating the curing to form the hydrogel.

They may further comprise a small amount of one or more of a co-curing agent, such as polyvalent metal compound and/or a cross-linking agent, such as a polyol, each of which may influence the formation and/or properties of the hydrogel.

A major disadvantage in the use of hydrogels based on alkali metal silicates and/or silica sols is that the production of suitable solutions for use in the CIP method is often complicated.

A further disadvantage is the high cost of the raw materials providing for the solutions and the hydrogels.

A major disadvantage in the use of hydrogels based on polyacrylates is that the hydrogels tend to be discoloured (yellowish) when they are prepared.

Accordingly, there exists a need for a fire-resistant layer which can be obtained without these disadvantages.

The present invention aims to meet that need by providing a fire-resistant layer comprising a hydrogel based on an aluminium 1,2,3-tricarboxylate.

In a first aspect, therefore, the present invention provides a fire-resistant glazing comprising a laminate of at least two transparent plies and at least one transparent fire-resistant layer wherein each fire-resistant layer is an interlayer for two plies and at least one fire-resistant interlayer comprises a hydrogel based on an aluminium 1,2,3-tricarboxylate.

References herein to a “hydrogel based on an aluminium 1,2,3-tricarboxylate” are references to a hydrogel comprising a 3-dimensional network (or “matrix”) structure formed predominantly by aluminium ion and at least one 1,2,3-tricarboxylate ion in water.

The at least one 1,2,3-tricarboxylate ion may comprise a 1,2,3-tricarboxylate ion having a-(CH₂)₃— or —CH₂CH═CH— unit which is unsubstituted or substituted by C₁-C₁₅ alkyl, C₁-C₁₅ alkenyl or C₆-C₁₀ aryl. This unit may alternatively or additionally be substituted by OH or NH₂ group. The substituent alkyl, alkenyl or aryl group may also be substituted by a polar group, for example, OH, Hal, SH or NH₂.

The at least one 1,2,3-tricarboxylate ion may, in particular, comprise a 1,2,3-tricarboxylate ion having a hydroxyl group adjacent to a carboxylate group.

The aluminium 1,2,3-tricarboxylate may comprise one or more of citrate, isocitrate, aconitate, carballylate, agarate, trimesate or hemimellitate.

In preferred embodiments, the at least one 1,2,3-tricarboxylate ion has 6, 7 or 8 carbon atoms, including those of the carboxylate groups.

In one such embodiment, the aluminium 1,2,3-tricarboxylate is aluminium citrate.

In that case, the hydrogel is a hydrogel based on aluminium citrate and comprises a 3-dimensional network (or “matrix”) structure formed predominantly by aluminium ion and citrate ion in water.

In this and other embodiments, the hydrogel may or may not include another 1,2,3-tricarboxylate ion.

In some embodiments, the hydrogel includes a minor amount (less than 15%, 10% or 5% by weight of the hydrogel) of different 1,2,3-tricarboxylate ion.

In other embodiments, the hydrogel includes a minor amount (less than 15%, 10% or 5% by weight of the hydrogel) of 1,x,y-tricarboxylate ion, wherein x is 2, 3 or 4 and y is 4 or 5 (of 6, 7, 8 carbon atoms, for example), or unsubstituted or hydroxy-substituted C₂-C₁₀ dicarboxylate ion.

These carboxylate ions may serve to prevent curing of the aqueous solution prior to the addition of a complexing agent.

Suitable di- or tri-carboxylates include malonic acid, succinic acid and glutaric acid as well as tartronic acid, malic acid and a-hydroxyglutaric acid.

Note that a hydrogel based on aluminium citrate differs from the hydrogel described in WO 2008/053248 A1. WO 2008/053248 A1 discloses improved fire-resistant glazing in which the fire-resistant layer comprises a hydrogel based on alkali metal silicates (with or without silica) which contains a small amount of a polyvalent metal compound.

The amount of the polyvalent metal compound (for example, aluminium citrate) in these hydrogels is from 0.2% to 1.0% by weight. An excessive amount of polyvalent metal compound is said to lead to brittleness of the interlayer which reduces the fire resistance of the fire-resistant glazing.

Note also that the hydrogel based on aluminium citrate differs from the hydrogel described in U.S. Pat. No. 5,766,770 A. U.S. Pat. No. 5,766,770 A discloses a fire-resistant glass structure comprising an intervening layer composed in major part of sodium water glass to which an organic component has been admixed, the organic component consisting of polyhydric organic compounds, and an amount of potassium water glass sufficient to substantially eliminate ultraviolet light sensitivity of the intervening layer. The intervening layer may comprise a metallo-organic compound of Si, Al, Ti or Zr for increasing viscosity of the layer on foaming in a case of exposure of the structure to fire.

It also differs from the hydrogel described in CN 106634908 A. CN 106634908 A discloses a polymer gel system for controlling the permeability of oil reservoir to injected water. The polymer gel system, which is said to offer long gelation time, high plugging performance and good (reservoir) temperature resistance, comprises a water glass, a cross-linking agent which is a hydrolysable ester compound, a cross-linking agent which may be aluminium citrate, and polymers selected from hydrolytic polyacrylamide, xanthan gum or cellulose, as well as additives such as bentonites or nano silica, diatomite or silicate, and water.

Such polymer gel systems are reviewed by Pinho de Aguiar, K. L. N. et al., in “A Comprehensive Review of In Situ Polymer Hydrogels for Conformance Control of Oil Reservoirs”, Oil & Gas Science and Technology-Rev. IFP Energies Nouvelles, 75, 8 (2020) found at https://doi.org/10.2516/ogst/2019067.

There, several studies examining the effect of polyvalent metal compounds (including aluminium citrate) on the cross-linking of partially hydrolysed polyacrylamides are mentioned.

Note also that the hydrogel based on aluminium citrate differs from fire retardant compositions for insulation products which comprise or use aluminium citrate.

US 2011/0266488 A1 discloses a fire-resistant thermal and/or acoustic insulation product that comprises a glass wool, an organic binder and a carboxylic acid metal salt as a fire retardant. Suitable organic carboxylic acid salts include aluminium citrate although the magnesium salts are described in detail.

U.S. Pat. No. 4,888,136 A discloses a composition useful as a flame retardant for a cellulosic material which comprises ammonium bromide and at least one water soluble aluminium salt of an organic hydroxy acid. The carboxylic acid may be an organic hydroxy carboxylic acid such as aluminium citrate, aluminium lactate or aluminium tartrate.

US 2014/0251184 A1 discloses a hydrothermal synthesis of (aluminium-containing) mica, especially zinc phlogopite, wherein single crystals (platelets) are produced with high aspect ratio. The platelets may be used in polymeric composites for improving the flame retardant properties of the composite by increasing the barrier properties of the composite and increased char formation upon ignition of the composite.

The hydrogel may comprise water in an amount greater than or equal to 35% by weight, for example, greater than or equal to 40% by weight.

Preferably, however, the hydrogel comprises water in an amount less than or equal to 50% by weight. A water content greater than 50% by weight tends to lead to haze resulting in poor optical quality of the hydrogel.

In some embodiments, the hydrogel contains an amount of water from 40% to 50% by weight. In these embodiments, the amount of water may, in particular, be 42%, 45% or 48% by weight.

The hydrogel may comprise aluminium 1,2,3-tricarboxylate in an amount calculated as the sum of aluminium ion and 1,2,3-tricarboxylate ion of at least 5% by weight.

For example, when the hydrogel is based on aluminium citrate, it may comprise aluminium citrate (Alₓ(Cit)_{y}, where Cit is citrate) in an amount calculated as the sum of aluminium ion and citrate ion of at least 5% by weight.

In embodiments, the hydrogel has an aluminium 1,2,3-tricarboxylate content from 5% to 45%, for example, 10%, 20%, 25%, 30%, 35%, 40% or 45%. In some embodiments, the hydrogel has an aluminium 1,2,3-tricarboxylate content from 5% to 10%.

The molar ratio of 1,2,3-tricarboxylate ion to aluminium ion in the hydrogel may be from 0.30 to 0.60. The molar ratio may, in particular, be 0.35, 0.40, 0.45, 0.50 or 0.55.

The hydrogel based on aluminium 1,2,3-tricarboxylate also comprises an ion derived from a complexing agent such as a polyhydroxy di- or tri-carboxylic acid or a salt thereof.

The complexing agent (or initiator) initiates curing of an aqueous solution of aluminium 1,2,3-tricarboxylate to form the hydrogel based on aluminium 1,2,3-tricarboxylate.

In preferred embodiments, the complexing agent is tartaric acid or a sodium or potassium salt thereof.

In embodiments, the hydrogel has a molar ratio of polyhydroxy di- or tri-carboxylate ion, for example, tartrate ion, to aluminium ion of from 0.06 to 0.20.

The hydrogel based on aluminium 1,2,3-tricarboxylate may further comprise one or more of a colourless additive, such as a plasticiser, an anti-freezing agent or a foaming agent.

These additives may be present in the hydrogel in an amount up to about 20% by weight provided that they are soluble in the aqueous solution of aluminium 1,2,3-tricarboxylate.

Suitable plasticizers include glycerol, ethylene glycol, diethylene glycol, polyethylene glycol and sorbitol.

In some embodiments, the hydrogel further comprise glycerol, ethylene glycol or sorbitol in amount up to 10% by weight, for example, 5% or 8% by weight.

In other embodiments, the hydrogel further comprises diethylene glycol in an amount up to 5% by weight, for example, 2% by weight.

In still other embodiments, the hydrogel further comprises poly-ethylene glycol 200 (PEG 200) in an amount up to 2.5% by weight.

Suitable anti-freezing agents include sodium chloride and potassium chloride.

These anti-freezing agents may be present in the hydrogel in an amount up to 10% by weight, for example, 7.5%, 5% or 2.5% by weight.

In some embodiments, the hydrogel further comprises sodium chloride in an amount up to 10% by weight, for example, 7.5%, 5% or 2.5% by weight.

In other embodiments, the hydrogel further comprises potassium chloride in an amount up to 2.5% by weight, for example, 1% or 2% by weight.

Suitable foaming agents include sodium carbonate, potassium carbonate and urea. These foaming agents may be present in the hydrogel in an amount up to 5%.

In some embodiments, the hydrogel further comprises potassium carbonate or urea in an amount up to 5% by weight, for example, 2%, 3% or 4% by weight.

In some embodiments the hydrogel further comprises a plasticiser in an amount up to 10% by weight and an anti-freezing agent in an amount up to 10% by weight.

The plasticiser may, in particular, be glycerol and the anti-freezing agent may be sodium chloride. In these embodiments, the hydrogel may have an aluminium citrate content from 5% to 10% by weight.

The transparent plies may comprise one or more glass panes or one or more of a polycarbonate panes. The glass panes may comprise a float glass, in particular, a soda lime glass. They may alternatively comprise an aluminosilicate or borosilicate glass.

In one embodiment, the fire-resistant glazing comprises three glass panes and two fire-resistant interlayers. In another embodiment, the fire-resistant glazing comprises four glass panes and three fire-resistant interlayers.

In embodiments, each fire-resistant interlayer may comprise a hydrogel based on an aluminium 1,2,3-tricarboxylate, for example, aluminium citrate.

The or each fire-resistant layer may have a thickness of from 5 mm to 35 mm, for example, from 10 to 30 mm, from 5 mm to 20 mm, or from 5 mm to 10 mm.

The glass or polycarbonate panes may each have a thickness from 1 mm to 10 mm, in particular, from 2 mm to 8 mm or from 3 mm to 6 mm.

Preferably, the glass panes are strengthened by one or more of heat treatment, tempering, toughening, chemical strengthening, addition of foil or laminate or a combination thereof.

In some embodiments, the glass panes are surface roughened or carry suitable coatings providing for improved adherence of the hydrogel to the glass panes.

The fire-resistant layer may cover substantially the whole of the surface area of one or both of the glass panes.

The fire-resistant glazing may be one that is ready for installation in a building or vehicle, or one that requires further processing.

Note that the use of the fire-resistant glazing is not particularly limited. It may be used in buildings or in vehicles, such as ships, planes and automobiles.

Current fire regulations classify the fire resistance of glazing by the measurement of the minimum time for which a glazing unit or assembly maintains: (i) its structural integrity (termed E); (ii) its structural integrity and radiation reduction within specified limits (termed EW); and (iii) its structural integrity and insulation within specified limits (termed El) when exposed to a fire.

Standard tests to determine the classification of the fire resistance of a glazing typically involve exposing one side of a glazing unit or assembly (the “fire side” or “hot side”) to a fire and monitoring the integrity of the glazing, and/or temperature levels on the opposing side of the glazing (the “cold side”) over time.

Preferably, the fire-resistant glazing according to the present invention conforms to at least EI 30 standard, preferably at least EI 60 standard, more preferably at least EI 90 standard, measured according to DIN EN 13501-2.

Preferably, the fire-resistant glazing according to the present invention conforms to at least EW 30 standard, preferably at least EW 60 standard, more preferably at least EW 90 standard, measured according to DIN EN 13501-2.

For maritime glazings, glazings may be classified using A and B standards according to IMO A.754 (18).

Preferably, the fire-resistant glazing according to the present invention conforms to at least A0 standard, preferably at least A15 standard, more preferably at least A30 standard, yet more preferably A60 standard according IMO A.754 (18).

Preferably, the fire-resistant glazing according to the present invention conforms to at least B0 standard, preferably at least B15, according to IMO A.754 (18).

For trains and transportation glazings may be classified using A1 and A2 standards according to EN 45545 part 3.

Preferably, the fire-resistant glazing according to the present invention conforms to at least A1-15 standard, preferably at least A1-30 standard, according to EN 45545 part 3.

Preferably, the fire-resistant glazing according to the present invention conforms to at least A2-15 standard, preferably at least A2-30 standard, according to EN 45545 part 3.

In a second aspect, the present invention provides a method for producing a fire-resistant laminated glazing comprising i) preparing a base solution of an aluminium 1,2,3-tricarboxylate in water, ii) adding a curing agent to the base solution and, optionally, one or more of a plasticiser, anti-freezing agent and foaming agent, iii) pouring the resultant solution into a cavity defined by two opposing transparent plies and a seal, and iv) curing the resultant solution in the cavity to form a fire-resistant interlayer comprising a hydrogel based on an aluminium 1,2,3-tricarboxylate.

The method may provide that the hydrogel based on aluminium 1,2,3-tricarboxylate has a water content of at least 35% by weight, for example, greater than or equal to 40% by weight.

The method may, for example, use one, two or three different 1,2,3-tricarboxylates provided that they provide an aqueous solution of an aluminium 1,2,3-tricarboxylate.

The 1,2,3-tricarboxylate may comprise a-(CH₂)₃— or —CH₂CH═CH— unit which is unsubstituted or substituted by C₁-C₁₅ alkyl, C₁-C₁₅ alkenyl or C₆-C₁₀ aryl. This unit or the substituent alkyl, alkenyl or aryl group may substituted by a polar group, for example, OH, Hal, SH or NH₂.

The 1,2,3-tricarboxylate may, in particular, comprise a 1,2,3-tricarboxylate having a hydroxyl group adjacent to a carboxylate group.

In preferred embodiments the method uses one or more of citrate, isocitrate, aconitate, carballylate, agarate, or hemimellitate.

In one such embodiment, the method forms a hydrogel based on aluminium citrate. In other words, the method forms a hydrogel comprising a 3-dimensional network (or “matrix”) structure formed predominantly by aluminium ion and citrate ion in water.

In preferred embodiments, the method provides that the hydrogel comprises water in an amount less than or equal to 50% by weight.

The method may, in particular, provide that the hydrogel contains water in an amount from 40% to 50% by weight, for example, 42%, 45% or 48%.

The method may provide that the base solution comprises aluminium 1,2,3-tricarboxylate in an amount from 5% to 45% by weight, for example, 10%, 15%, 20%, 25%, 30%, 35%, 40% or 45%.

In some embodiments, the method provides that that the base solution comprises aluminium 1,2,3-tricarboxylate in an amount from 5% to 10% by weight.

The base solution is a precursor solution for the hydrogel. The preparation of the base solution may comprise i) adding a predetermined amount of water to a mixture of at least one sodium or potassium salt of a 1,2,3-tricarboxylate acid and an inorganic aluminium compound, ii) adding an aqueous solution of an alkali metal base until the mixture has a pH from 6.0 to 9.0 and iv) stirring the mixture until a clear solution is obtained.

The inorganic aluminium compound may be a compound of general formula AlₓR_{y} wherein R is an inorganic radical, such as phosphate, nitrate or chloride, and wherein x has a value of 1 or 2, y has a value of 1, 2 or 3 and x and y together provide for balancing of valency.

In one embodiment, the mixture is a mixture of aluminium phosphate (AIPO₄) and trisodium citrate.

The method may provide that the base solution has a molar ratio of 1,2,3-tricarboxylate ion to aluminium ion from 0.30 to 0.60.

The predetermined amount of water added to the mixture will reflect the desired amount of water in the hydrogel- and should take into account the amount of water in other solutions used in the method. The base solution may, in particular, contain up to 10%, for example, 5% or 2% less water than the hydrogel.

The aqueous solution of alkali metal base allows fine control over pH and the amount of water in the hydrogel. Preferably, the aqueous solution of alkali metal base comprises 50% (by weight) potassium hydroxide in water.

Note, however, that a more dilute solutions or a solution of a weaker base in water may be used alone or in combination with the addition of the predetermined amount of water.

The selection of the molar ratio of 1,2,3-tricarboxylate ion to aluminium ion, the predetermined amount of water and the pH of the base solution provides for different curing conditions as well as different properties in the hydrogel.

In the case that the hydrogel is a hydrogel based on aluminium citrate, when the molar ratio of citrate ion to aluminium ion in the base solution is from 0.3 to 0.6 and its water content is from 45% to 50% by weight, a pH of 9 provides that the resultant solution cures at room temperature. A pH of 6, however, provides that the resultant solution cures on heating to an elevated temperature (such as 80° C.).

When the molar ratio of citrate ion to aluminium ion in the base solution is 0.3, its water content is from 45% to 50% and its pH is 9, the resultant solution cures to a hard gel at room temperature within 6 hours. If, however, the molar ratio of citrate ion to aluminium ion is 0.6 the resultant solution cures to a soft gel over 12 or more hours.

The addition of the curing agent to the base solution may comprise adding a polyhydroxy di- or tri-carboxylic acid, such as tartaric acid, or a salt thereof, to the base solution. The salt may, in particular, be a mono- or di-sodium or potassium salt, such as disodium tartrate.

Note that the curing agent is a strong complexing agent which starts or is necessary for forming a stable hydrogel based on aluminium citrate.

The amount of curing agent should be sufficient to provide for curing of the resultant solution. In embodiments, the addition of polyhydroxy di- or tri-carboxylic acid or salt thereof, provides that the molar ratio of carboxylic acid ion, for example tartrate ion, to aluminium ion in the resultant solution is from 0.06 to 0.20.

The adding of the curing agent may comprise adding a solution of the curing agent in water. The curing solution may, for example, comprise a solution of disodium tartrate in water having molarity from 0.5 M to 3.0 M, for example, 1.5 M.

In general, the method comprises curing the resultant solution at a temperature from 25° C. to 90° C. for 2 hours to 24 hours.

The method may include adding a stabiliser, such as sodium or potassium phosphate, in an amount sufficient to prevent crystallisation from the base solution.

In some embodiments, the method further comprises adding one or more of an additive such as a plasticiser, an anti-freezing agent or a foaming agent to the base solution.

These additives may be used in an amount up to about 20% by weight of the resultant solution—provided that they are soluble in that solution.

The one or more additive may be added prior to adding the curing agent or at the same time as adding the curing agent.

In a preferred embodiment, the method comprises adding a curing agent and the one or more of an additive to the base solution, for example, as a curing solution containing the curing agent and the one or more additive the additive.

Suitable plasticizers include glycerol, ethylene glycol, diethylene glycol, polyethylene glycol and sorbitol.

In some embodiments, the method further comprises adding one or more of glycerol, ethylene glycol or sorbitol in an amount up to 10% by weight, for example, 5% or 8% by weight, of the resultant solution.

In other embodiments, the method further comprises adding diethylene glycol in an amount up to 5% by weight, for example, 2% by weight, of the resultant solution.

In still other embodiments, the method further comprises adding polyethylene glycol 200 (PEG 200) in an amount up to 2.5% by weight of the resultant solution.

Suitable anti-freezing agents include sodium chloride and potassium chloride.

These anti-freezing agents may be added in an amount up to 10% by weight, for example, 7.5%, 5% or 2.5% by weight, of the resultant solution.

In some embodiments, the method further comprises adding sodium chloride in an amount up to 7.5% by weight, for example, 5% or 2.5% by weight of the resultant solution.

In other embodiments, the method comprises adding potassium chloride in an amount up to 2.5% by weight, for example, 1% or 2% by weight of the resultant solution.

Suitable foaming agents include sodium carbonate, potassium carbonate and urea. These foaming agents may be added in an amount up to 5%, for example, 2%, 3% or 4% by weight, of the resultant solution.

In some embodiments, the method further comprises adding potassium carbonate or urea in an amount up to 5% by weight, for example, 2%, 3% or 4% by weight of the resultant solution.

In a preferred embodiment, the method further comprises adding a plasticiser in an amount up to 10% by weight of the resultant solution and an anti-freezing agent in an amount up to 10% by weight of the resultant solution.

Other embodiments in the second aspect will be apparent from those of the first aspect of the present invention.

In particular, the method may include minor amounts of one or more of a sodium or potassium salt of the aforementioned dicarboxylic and tricarboxylic acids and a source of phosphate ion to prepare the base solution.

In a third aspect, the present invention provides a method for the preparation of a base solution for forming a fire-resistant inter-layer in a fire-resistant laminated glazing, the method comprising i) adding a predetermined amount of water to a mixture of at least one sodium or potassium salt of a 1,2,3-tricarboxylic acid and an inorganic aluminium compound, ii) adding an aqueous solution of an alkali metal base until the mixture has a pH from 6.0 to 9.0 and iv) stirring the mixture until a clear solution is obtained.

Embodiments in the third aspect will be apparent from those of the first and second aspects of the present invention.

In a fourth aspect, the present invention provides a base solution for preparing a fire-resistant interlayer in a fire-resistant glazing.

Embodiments in the fourth aspect will be apparent from those of the first and second aspects of the present invention.

The base solution may, in particular, comprise a solution of aluminium citrate in water in which the aluminium citrate content is from 5% to 10% by weight, the molar ratio of citrate to aluminium is from 0.3 to 0.6, the water content is about 45% to 50% by weight (for example, 40% to 45%) by weight and the pH is from 6 to 9.

In a fifth aspect, the present invention provides for use of a hydrogel based on an aluminium 1,2,3-tricarboxylate as a fire-resistant interlayer in a fire-resistant glazing.

Embodiments in the fifth aspect will be apparent from those of the first and second aspects of the present invention.

In a sixth aspect, the present invention provides a fire-resistant glazing unit or assembly, such as a door, an openable window or a shutter assembly, comprising the fire-resistant glazing of the first aspect.

Embodiments in the sixth aspect will be apparent from those of the first and second aspects of the present invention.

In a seventh aspect, the present invention provides for use of a fire resistant glazing assembly according to the sixth aspect in a building or in a vehicle such as a train or a ship.

Embodiments in the seventh aspect will be apparent from those of the first and second aspects of the present invention.

The present invention will now be described in more detail with reference to the following non-limiting embodiments and the accompanying drawings in which:

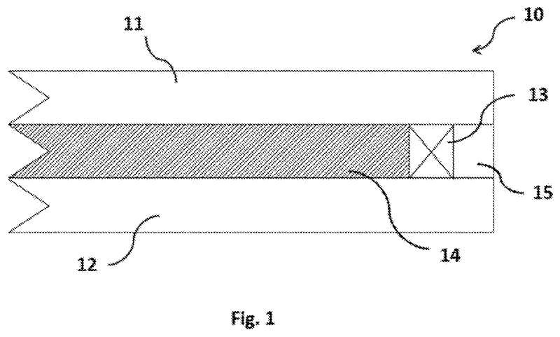

FIG. 1 is a cross-section view of part of a fire resistant glazing according to one embodiment of the present invention; and

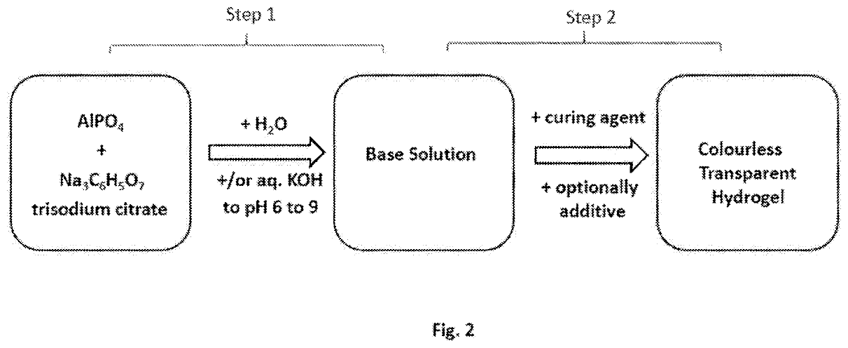

FIG. 2 is a scheme showing a method for the production of a fire-resistant glazing according to one embodiment of the present invention.

Referring now to FIG. 1, a fire-resistant glazing, 10 according to one embodiment of the present glazing comprises two opposing float glass panes 11, 12 of dimensions (h×w) about 2000 mm×1000 mm and thickness 8 mm.

A spacer 13 is provided between the glass panes 11, 12 to maintain an intervening fire-resistant layer 14 comprising a hydrogel based on aluminium citrate with thickness of 6 mm. A sealant 15 is provided between the glass panes 11, 12 and adjacent the spacer 13 to maintain the mechanical stability of the glazing and ensure that the glass panes 11, 12 do not become separated during handling and transport. The spacer 13 and the sealant 15 extend along substantially the whole of the periphery of the glazing 10.

FIG. 2 shows a two-step process to produce the fire-resistant glazing shown in FIG. 1 as a cast-in-place process.

The first step (step 1) comprises preparing a base solution for curing between the glass panes 11, 12. The second step (step 2) comprises curing the base solution between the glass panes 11, 12.

One procedure for obtaining the base solution comprises mixing suitable quantities of trisodium citrate and aluminium phosphate with strong stirring.

After enough mixing of the solids, a calculated amount of water (providing for a target water content in the hydrogel) is added with continued stirring.

After the addition of the water, an aqueous solution of potassium hydroxide (for example, 50% KOH by weight) is slowly added to the stirred wet mixture with cooling (below about 50° C.) until the wet mixture reaches a desired pH (providing for a target curing temperature and/or properties of the hydrogel). The stirring is continued (under vacuum) until a clear and colorless solution is obtained (normally two to three hours).

The base solution so obtained can be stored at ambient temperature until it is needed, or it can be used immediately in the second step.

One procedure for the curing the base solution between the glass panes 11, 12 comprises adding a suitable amount of an aqueous solution of disodium tartrate (as a curing agent) to the base solution followed by pouring the base solution into a (6 mm wide) cavity between the glass panes 11, 12 (and a seal, not shown).

If an additive is to be used, it may be added to the base solution at the same time as the addition of the solution of disodium tartrate. Alternatively, it can be added to the solution of with disodium tartrate (if it is soluble therein) prior to the addition to the base solution.

Immediately following the addition of disodium tartrate (and optionally, additive), the base solution is poured into the cavity between the glass panes 11, 12.

The glass panes 11, 12 and base solution are maintained at a temperature between 25° C. and 90° C. for a time ensuring that the base solution cures to a hydrogel based on aluminium citrate.

### EXAMPLE

### Step 1-Preparation of Base Solution

5 kg of base solution is prepared by mixing 525 g trisodium citrate and 95.4 g H₂O with 2.86 kg of aluminium phosphate (AIPO₄; 50% by weight) under heavy stirring. Subsequently, 1030 mL of aqueous potassium hydroxide (50% KOH by weight) is added slowly under cooling. The temperature during this process is kept below 50° C. After this addition is completed, the mixture is stirred 2 to 3 hours under vacuum until it becomes a clear and colorless solution.

### Step 2-Forming Hydrogel Interlayer

A mixture of 327.5 mL of 1.5M sodium tartrate solution, 331 g glycerol, and 4.2 mL of water is stirred until a clear and colorless solution is obtained.

This solution is immediately added to the base solution obtained from step (i) and the whole stirred until a homogenous solution is obtained.

TABLE 1

| | |
|---|---|
| Water content [%] | 45.9% |
| Molar ratio Citrate/Aluminum | 0.4 |
| pH value of solution | 6.5 |
| Molar ratio Tartrate/Aluminum | 0.11 |
| Glycerol | 5% |

The solution so obtained (viz., the base solution containing sodium tartrate and glycerol) has a low, water like viscosity and has the composition set out in Table 1 above.

This solution is poured immediately into the cavity between the opposing glass panes until the cavity is completely full. The cavity is sealed, and the curing is carried out by firing the assembly for 4 hours in an autoclave heated to 80° C.

The fire-resistant interlayer obtained has the same composition as the solution (shown in Table 1). It has good adhesion to the glass panes 11, 12, good mechanical stability and very good optical appearance.

Rapid ageing tests show good ageing performance. The ageing performance may be improved by selection of additives amongst those mentioned above.

The fire-resistant glazing shows a fire and smoke resistance performance of EI18 when exposed in a standard frame to a gas burner heat source in accordance with DIN EN 13501-1.

This performance is comparable to similar fire-resistant glazings in which the fire-resistant layer comprises a hydrogel based on polyacrylate.

Performances of at least EI30, EI60 and E190 may be obtained by selection of additives amongst those mentioned above and an appropriate thickness for the fire-resistant layer.

Table 2 below sets out EI performances of a fire resistant glazing in which the fire-resistant layer comprises one such hydrogel (aluminium citrate content from 5% to 10% by weight) at various thicknesses of that layer.

TABLE 2

| Interlayer thickness/mm | EI performance/min | Interlayer composition |
|---|---|---|
| 5.5 | 13.8 | 42.7% H₂O; pH 6.5; 5% |
| 6 | 18.8 | Glycerol; 5% NaCl (by |
| 8 | 24.5 | weight) |
| 10 | 33.3 | |

The present invention provides a fire-resistant glazing having a fire-resistant interlayer which can be prepared from readily available and cheap materials (for example, trisodium citrate and aluminium phosphate) in a straightforward method.

The two-step method is suitable for on-line production of fire-resistant glazings.

The base solution can be stored at ambient temperature for prolonged periods (months) without discolouration or deterioration.

The base solution containing initiator can be easily poured between glass panes (it has a viscosity similar to water) without entrapment of air.

The fire-resistant interlayer can be a cheap alternative to fire-resistant layers comprising hydrogels based on alkali metal silicates or polyacrylates and has EI standard performance comparable with hydrogels based on polyacrylates.

The fire-resistant interlayer can have superior optical appearance as compared to fire-resistant layers comprising hydrogels based on polyacrylates because it may be colourless and transparent even at large thicknesses.

1. A fire-resistant glazing comprising a laminate of at least two transparent plies and at least one transparent fire-resistant layer wherein:
each fire-resistant layer is an interlayer for two plies; and
at least one fire-resistant interlayer comprises a hydrogel based on an aluminium 1,2,3-tricarboxylate.

2. A glazing according to claim 1, wherein the 1,2,3-tricarboxylate comprises a 1,2,3-tricarboxylate having a hydroxyl group adjacent to a carboxylate group.

3. A glazing according to claim 1 or claim 2, wherein the 1,2,3-carboxylate comprises one or more of citrate, isocitrate, aconitate, carballylate, agarate or hemimellitate.

4. A glazing according to any preceding claim, wherein the hydrogel has a water content greater than or equal to 40% by weight.

5. A glazing according to any preceding claim, wherein the hydrogel has a water content less than or equal to 50% by weight.

6. A glazing according to any preceding claim, wherein the hydrogel has an aluminium 1,2,3-tricarboxylate content from 5% to 45% by weight.

7. A glazing according to any preceding claim, wherein the hydrogel has a molar ratio of 1,2,3-tricarboxylate ion to aluminium ion from 0.30 to 0.60.

8. A glazing according to any preceding claim, wherein the hydrogel further comprises a polyhydroxy di- or tri-carboxylic acid or salt thereof.

9. A glazing according to claim 8, wherein the hydrogel has a molar ratio of polyhydroxy di- or tri-carboxylate ion to aluminium ion from 0.06 to 0.20.

10. A glazing according to any preceding claim, wherein the hydrogel further comprises a plasticizer in an amount less than or equal to 10% by weight.

11. A glazing according to any preceding claim, wherein the hydrogel further comprises an anti-freezing agent in an amount less than or equal to 10% by weight.

12. A glazing according to any preceding claim, wherein the hydrogel further comprises a foaming agent in an amount less than or equal to 5% by weight.

13. A glazing according to any preceding claim, wherein the aluminium 1,2,3-tricarboxylate is aluminium citrate.

14. A method for producing a fire-resistant laminated glazing comprising:
i) preparing a base solution of an aluminium 1,2,3-tricarboxylate in water;
i) adding a curing agent to the base solution and, optionally one or more of an additive to the base solution;
iii) pouring the base solution into a cavity defined by two opposing transparent plies and a seal; and
iv) curing the base solution in the cavity to form a fire-resistant interlayer comprising a hydrogel based on aluminium 1,2,3-tricarboxylate.

15. A method according to claim 14, wherein at least one 1,2,3-tricarboxylate comprises a hydroxyl group adjacent to a carboxylic acid group.

16. A method according to claim 14 or claim 15, wherein the 1,2,3-tricarboxylate is at least one of citrate, isocitrate, aconitate, carballylate, agarate or hemimellitate.

17. A method according to any of claims 14 to 16, providing that the hydrogel has a water content greater than or equal to 40% by weight.

18. A method according to any of claims 14 to 17, providing that the hydrogel has a water content less than or equal to 50% by weight.

19. A method according to any of claims 14 to 18, providing that the hydrogel has an aluminium 1,2,3-tricarboxylate content from 5% to 45% by weight.

20. A method according to any of claims 14 to 19, providing that the hydrogel has a molar ratio of 1,2,3-tricarboxylate ion to aluminium ion from 0.30 to 0.60.

21. A method according to any of claims 14 to 20, wherein preparing the base solution comprises:
i) adding a predetermined amount of water to a mixture of at least one sodium or potassium salt of a 1,2,3-tricarboxylic acid and aluminium phosphate;
ii) adding an aqueous solution of an alkali metal base until the mixture has a pH from 6 to 9; and
iii) stirring the mixture until a clear solution is obtained.

22. A method according to any of claims 14 to 21, wherein adding the curing agent comprises adding a solution of a polyhydroxy di- or tri-carboxylic acid or salt thereof in water.

23. A method according to claim 22, wherein the addition of polyhydroxy di- or tri-carboxylate ion provides that the base solution has a molar ratio of tartrate ion to aluminium ion from 0.06 to 0.20.

24. A method according to any of claims 14 to 23, further comprising adding a plasticiser to the base solution in an amount less than or equal to 10% by weight.

25. A method according to any of claims 14 to 24, further comprising adding an anti-freezing agent to the base solution in an amount less than or equal to 10% by weight.

26. A method according to any of claims 14 to 25, further comprising adding a foaming agent to the base solution in an amount less than or equal to 5% by weight.

27. A method according to any of claims 14 to 26, wherein the curing is carried out at a temperature from 25° C. to 90° C. for 2 hours to 24 hours.

28. A method for the preparation of a base solution for forming a fire-resistant interlayer in a fire-resistant laminated glazing, the method comprising:
adding a predetermined amount of water to a mixture of at least one sodium or potassium salt of 1,2,3-tricarboxylic acid and aluminium phosphate;
adding a solution of an aqueous solution of an alkali metal base to the mixture until a pH from 6.0 to 9.0 is obtained; and
stirring the mixture until a clear solution is obtained.

29. A base solution for forming a fire-resistant layer for a fire-resistant laminated glazing, comprising a solution of an aluminium 1,2,3-tricarboxylate in water at pH from 6.0 to 9.0.

30. Use of a hydrogel based on an aluminium 1,2,3-tricarboxylate as a fire-resistant layer in a fire-resistant laminated glazing.
